(19) United States
(12) Patent Application Publication
(10) Pub. No.: US 2026/0358534 A1
(43) Pub. Date: Nov. 12, 2026

(54) LENS MODULE AND LENS BARREL

(71) Applicant: Newmax Technology Co., Ltd., Taichung City (TW)

(72) Inventors: Yung-Fu LIANG, Taichung City (TW); Tsung-Kuei WANG, Taichung City (TW)

(21) Appl. No.: 19/297,318

(22) Filed: Aug. 12, 2025

(30) Foreign Application Priority Data
May 6, 2025 (TW) 114117056

(51) Int. Cl. G02B 5/00; G02B 7/02

(52) U.S. Cl. CPC G02B 5/003; G02B 7/02

(57) ABSTRACT

A lens barrel defines an object side and an image side opposite to the object side, and includes: a barrel body, a microstructure region and a protruding structure region. The barrel body includes a first object-side surface. The microstructure region is located on the first object-side surface. The microstructure region includes a plurality of microstructural portions. The protruding structure region surrounds the microstructure region. The protruding structure region is closer to the object side than the microstructure region, so as to protect the microstructure region from damage.

### CROSS-REFERENCE TO RELATED APPLICATION

This application claims the benefit of Taiwan Patent Application No. 114117056, filed on May 6, 2025, which is hereby incorporated by reference for all purposes as if fully set forth herein.

### BACKGROUND

### Technical Field

The present disclosure relates to a lens module, and in particular to a lens module, wherein a protruding structure region of a lens barrel of the lens module is closer to the object side than a microstructure region.

### Related Art

Stray light is a general term for unwanted light in a lens module, such as residual reflection on the surface of the lens barrel. Stray light can cause the performance of the lens module to decay, reduce the modulation transfer function of the lens module, and endanger the imaging quality of the optical lens, which is manifested in reduced image clarity, reduced layering, and reduced color saturation.

A microstructure region is made on the surface of the lens barrel, and the microstructure region has a unique structure. If the microstructure region is damaged (such as crushed or bruised), the surface color of the lens barrel will change from the original dark black to grayish white. Such damage not only affects the appearance of the lens module, but also causes the surface of the lens barrel to be unable to effectively reduce the light reflectivity, and loses the original anti-reflection effect.

Furthermore, when the lens barrel with the microstructure region is cleaned, inspected, assembled, tested and other manufacturing processes in the factory, the microstructure region of the lens barrel is relatively fragile and is easily damaged by collision or wear during the manufacturing process. The appearance and performance of the lens barrel with the microstructure region are more easily affected by slight damage, which not only reduces the product yield in the manufacturing process, but also requires more rigorous quality control of the lens barrel with the microstructure region.

The patent document (TW publication number: I823385B) has disclosed component for a lens module including: a component surface; a flat region located on the component surface; and a microstructure region located on the component surface and adjacent to the flat region; wherein relative to the flat region, the microstructure region includes a plurality of microstructural portions and a plurality of concave portions. However, the patent document does not disclose how to protect the microstructure region from damage.

Therefore, it is necessary to provide a lens module and a lens barrel for improving an image quality, so as to resolve the foregoing problems.

### SUMMARY

An objective of the present disclosure is to provide a lens module, wherein a protruding structure region of a lens barrel of the lens module is closer to the object side than a microstructure region, so as to protect the microstructure region from damage.

To achieve the above objective, the present disclosure provides a lens barrel defines an object side and an image side opposite to the object side, and comprising: a barrel body including a first object-side surface; a microstructure region located on the first object-side surface, wherein the microstructure region includes a plurality of microstructural portions; and a protruding structure region surrounding the microstructure region, wherein the protruding structure region is closer to the object side than the microstructure region, so as to protect the microstructure region from damage.

The present disclosure further provides a lens module, comprising: the above-mentioned lens barrel; and an optical lens assembly disposed in the lens barrel and comprising a plurality of optical lenses.

The object-side surface of the lens barrel of the lens module of the present disclosure is processed by a molding process (e.g., an injection molding process), whereby the microstructure region generating multiple reflections of light is formed on the object-side surface of the lens barrel, so as to change the scattering distribution characteristics of the object-side surface of the lens barrel to achieve the effect of suppressing stray light. Furthermore, the protruding structure region of the lens barrel of the lens module of the present disclosure is closer to the object side than the microstructure region, so as to protect the microstructure region from damage.

### BRIEF DESCRIPTION OF THE DRAWINGS

FIG. 1 is a schematic plan view of a lens barrel according to the first embodiment of the present disclosure.

FIG. 2 is a schematic cross-sectional view of a lens barrel according to the first embodiment of the present disclosure.

FIG. 3 is a schematic perspective view of a microstructure region of a lens barrel according to an embodiment of the present disclosure.

FIG. 4 is a schematic perspective view (I) of a lens barrel according to the first embodiment of the present disclosure.

FIG. 5 is a schematic perspective view (II) of a lens barrel of the first embodiment of the present disclosure.

FIG. 6 is a schematic perspective view (III) of a lens barrel of the first embodiment of the present disclosure.

FIG. 7 is a schematic perspective view (IV) of a lens barrel of the first embodiment of the present disclosure.

FIG. 8 is a schematic perspective view (I) of a lens barrel of the second embodiment of the present disclosure.

FIG. 9 is a schematic perspective view (II) of a lens barrel of the second embodiment of the present disclosure.

FIG. 10 is a schematic exploded perspective view of a lens module according to an embodiment of the present disclosure.

### DETAILED DESCRIPTION

To make the foregoing objective, features, and characteristics of the present disclosure clearer and more comprehensive, detailed descriptions are provided below with reference to the accompanying drawings.

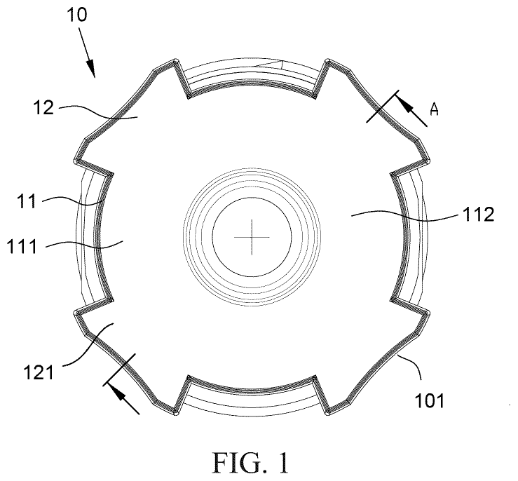

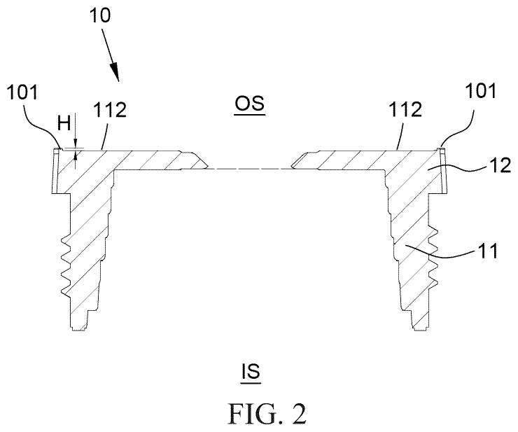

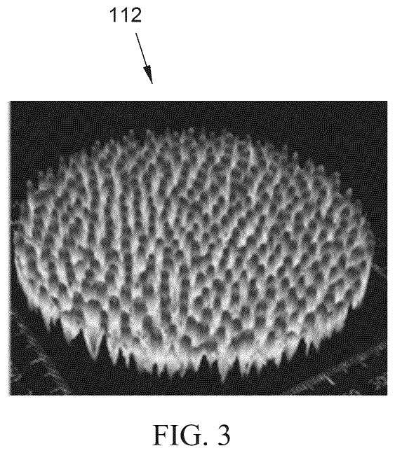

FIG. 1 is a schematic plan view of a lens barrel according to the first embodiment of the present disclosure. FIG. 2 is a schematic cross-sectional view of a lens barrel according to the first embodiment of the present disclosure. FIG. 3 is a schematic perspective view of a microstructure region of a lens barrel according to an embodiment of the present disclosure. Referring to FIG. 1 and FIG. 2, the lens barrel 10 defines an object side OS and an image side IS located opposite to the object side, and includes: a barrel 11 including the first object-side surface 111; a microstructure region 112 located on the first object-side surface 111, wherein the microstructure region 112 includes a plurality of microstructural portions (as shown in FIG. 3), wherein any area of 0.1 mm*0.1 mm in the microstructure region has n microstructural portions, and the following conditions are satisfied: 10≤n≤90; and a protruding structure region 101 surrounding the microstructure region 112, wherein the protruding structure region 101 is closer to the object side OS than the microstructure region 112, so as to protect the microstructure region 112 from damage. The protruding structure region 101 is more protruding than the microstructure region 112, and the protruding height H of the protruding structure region 101 is from 0.005 mm to 0.50 mm, so as to protect the microstructure region 112 from being damaged by collision or wear. Preferably, the protruding height H of the protruding structure region 101 is from 0.02 mm to 0.10. The roughness of the protruding structure region 101 can be from 0.005 mm to 0.030 mm. In the first embodiment, the lens barrel 10 is a two-piece lens barrel, and the lens barrel 10 further includes a plurality of petal portions 12, which surround the first object-side surface 111 of the barrel body 11, and each petal portion 12 includes a second object-side surface 121. The petal portions 12 are integrally formed with the barrel body 11. The first object-side surface 111 and the second object-side surface 121 can be called a sky surface of the lens barrel 10.

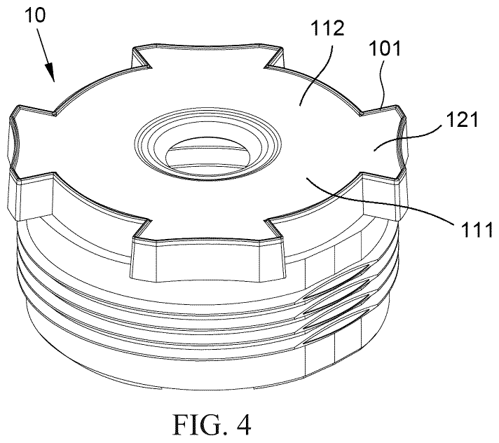

FIG. 4 is a schematic perspective view (I) of a lens barrel according to the first embodiment of the present disclosure. In one embodiment, the protruding structure region 101 completely surrounds the microstructure region 112, and the protruding structure region 101 is located at an edge of the first object-side surface 111 and an edge of the second object-side surface 121. Completely surrounding the microstructure region 112 means that the protruding structure region 101 continuously surrounds the edge of the first object-side surface 111 and the edge of the second object-side surface 121, and preferably has the effect of protecting the microstructure region 112 from damage.

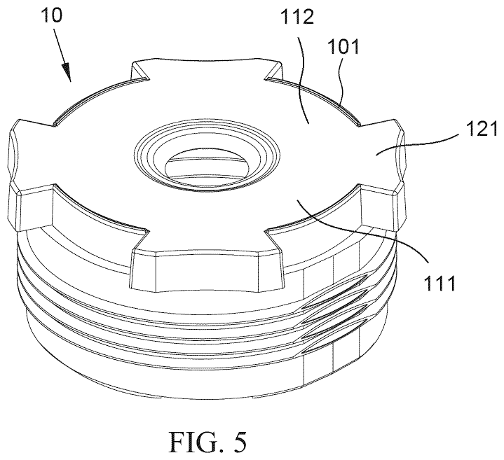

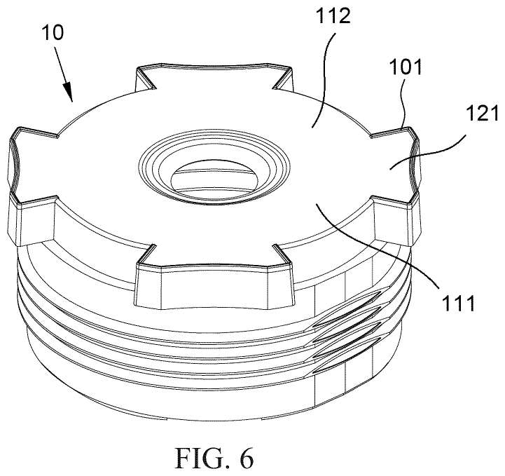

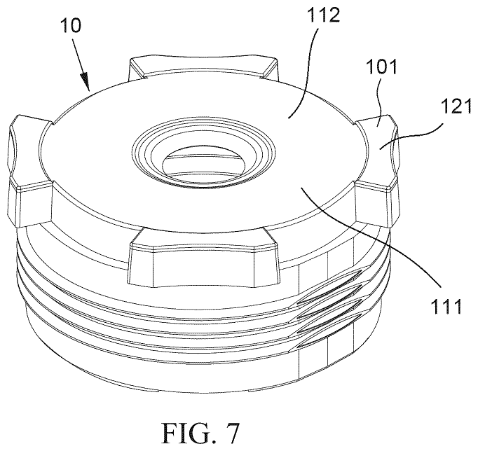

FIG. 5 is a schematic perspective view (II) of a lens barrel of the first embodiment of the present disclosure. In another embodiment, the protruding structure region 101 partially surrounds the microstructure region 112, and the protruding structure region 101 can be located at an edge of the first object-side surface 111 (shown in FIG. 5). FIG. 6 is a schematic perspective view (III) of a lens barrel of the first embodiment of the present disclosure. In a further embodiment, the protruding structure region 101 partially surrounds the microstructure region 112, and the protruding structure region 101 can be located at an edge of the second object-side surface 121 (shown in FIG. 6). FIG. 7 is a schematic perspective view (IV) of a lens barrel of the first embodiment of the present disclosure. In other embodiments, the protruding structure region 101 partially surrounds the microstructure region 112, and the protruding structure region 101 can be located at the entire surface of the second object-side surface 121 (shown in FIG. 7). Partially surrounding the microstructure region 112 means that the protruding structure region 101 discontinuously surrounds the edge of the first object-side surface 111 and/or the edge of the second object-side surface 112, and has the effect of protecting the microstructure region 112 from damage.

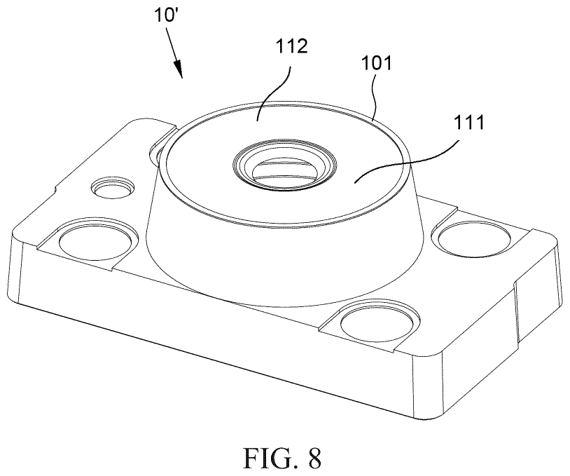

FIG. 8 is a schematic perspective view (I) of a lens barrel of the second embodiment of the present disclosure. The lens barrel 10′ of the second embodiment is substantially similar to the lens barrel 10 of the first embodiment, and similar elements are marked with similar reference numerals. In the second embodiment, the lens barrel 10′ is a one-piece lens barrel, and the lens barrel 10 does not include a petal portion. The protruding structure region 101 completely surrounds the microstructure region 112, and the protruding structure region 101 can be located at an edge of the first object-side surface 111. Completely surrounding the microstructure region 112 means that the protruding structure region 101 continuously surrounds the edge of the first object-side surface 111, and preferably has the effect of protecting the microstructure region 112 from damage.

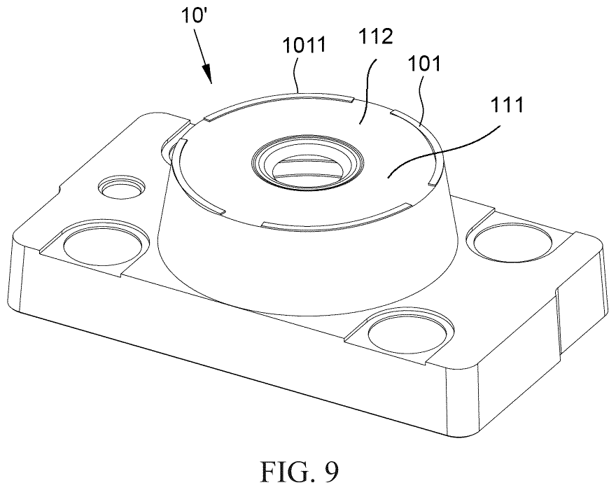

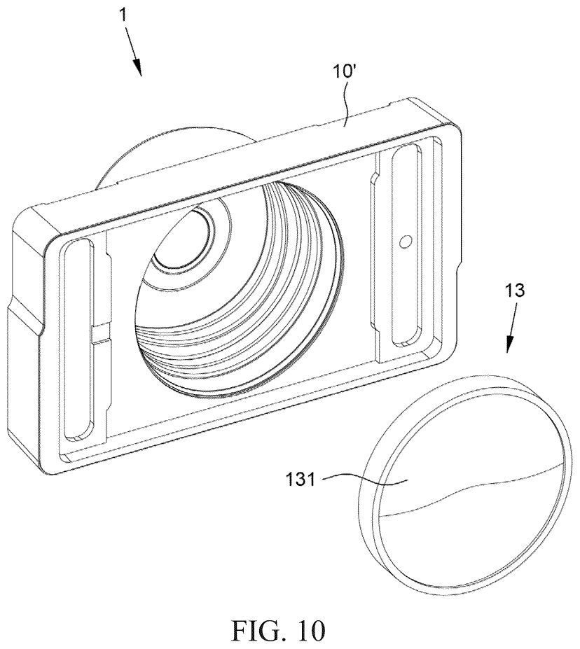

FIG. 9 is a schematic perspective view (II) of a lens barrel of the second embodiment of the present disclosure. In other embodiments, the lens barrel 10′ is a one-piece lens barrel, the protruding structure region 101 partially surrounds the microstructure region 112, and the protruding structure region 101 can be located at an edge of the first object-side surface 111. The protruding structure region 101 includes at least two arc-shaped regions 1011, and satisfies the following condition: 0.4≤t a ratio of sum of lengths of the arc-shaped regions 1011 of the protruding structure region 101 to a circumference of the first object-side surface 111≤0.9, but is not limited thereto. Partially surrounding the microstructure region 112 means that the protruding structure region 101 discontinuously surrounds the edge of the first object-side surface 111 in a circle, and has the effect of protecting the microstructure region 112 from damage.
FIG. 10 is a schematic exploded perspective view of a lens module according to an embodiment of the present disclosure. The lens module includes: the above-mentioned lens barrel 10′ and an optical lens assembly 13, the optical lens assembly 13 is disposed in the lens barrel 10′ and includes a plurality of optical lenses 131, but is not limited thereto. The object-side surface of the lens barrel of the lens module of the present disclosure is processed by a molding process (e.g., an injection molding process), whereby the microstructure region generating multiple reflections of light is formed on the object-side surface of the lens barrel, so as to change the scattering distribution characteristics of the object-side surface of the lens barrel to achieve the effect of suppressing stray light. Furthermore, the protruding structure region of the lens barrel of the lens module of the present disclosure is closer to the object side than the microstructure region, so as to protect the microstructure region from damage.

The lens module of the present disclosure can be applied to photography, monitoring, automation equipment, vehicle surround systems, and electronic imaging systems in Internet of Things devices according to needs, but is not limited thereto.

In conclusion, preferred implementations or embodiments of the technical means adopted by the present disclosure to resolve the problems of the present disclosure are merely recorded, and are not intended to limit the scope of implementation of the present disclosure. That is, any equivalent changes and modifications literally conforming to the scope of the claims of the present disclosure or made according to the scope of the claims of the present disclosure shall fall within the scope of the present disclosure.

What is claimed is:

1. A lens barrel defines an object side and an image side opposite to the object side, and comprising:
a barrel body including a first object-side surface;
a microstructure region located on the first object-side surface, wherein the microstructure region includes a plurality of microstructural portions; and
a protruding structure region surrounding the microstructure region, wherein the protruding structure region is closer to the object side than the microstructure region, so as to protect the microstructure region from damage.

2. The lens barrel according to claim 1, wherein the protruding structure region is more protruding than the microstructure region, and has a protruding height of 0.005-0.50 mm.

3. The lens barrel according to claim 1, wherein the lens barrel is a two-piece lens barrel, the lens barrel further comprises a plurality of petal portions, the petal portions surround the first object-side surface of the barrel body, and each petal portion comprises a second object-side surface.

4. The lens barrel according to claim 3, wherein the protruding structure region completely surrounds the microstructure region, and the protruding structure region is located at an edge of the first object-side surface and an edge of the second object-side surface.

5. The lens barrel according to claim 3, wherein the protruding structure region partially surrounds the microstructure region, and the protruding structure region is located at an edge of the first object-side surface; the protruding structure region is located at an edge of the second object-side surface; or the protruding structure region is located on the entire surface of the second object-side surface.

6. The lens barrel according to claim 1, wherein the lens barrel is a one-piece lens barrel, the protruding structure region surrounds the microstructure region, and the protruding structure region is located at an edge of the second object-side surface.

7. The lens barrel according to claim 1, wherein the lens barrel is a one-piece lens barrel, the protruding structure region partially surrounds the microstructure region, and the protruding structure region is located at an edge of the first object-side surface.

8. The lens barrel according to claim 1, wherein the protruding structure region partially surrounds the microstructure region, the protruding structure region comprises at least two arc-shaped regions, and satisfies the following condition: 0.4≤a ratio of sum of lengths of the arc-shaped regions of the protruding structure region to a circumference of the first object-side surface≤0.9.

9. The lens barrel according to claim 1, wherein a roughness of the protruding structure region is from 0.005 mm to 0.030 mm, any area of 0.1 mm*0.1 mm in the microstructure region has n microstructural portions, and the following conditions are satisfied: 10≤n≤90.

10. A lens module, comprising:
a lens barrel, wherein:
the lens barrel defines an object side and an image side opposite to the object side, and comprising:
a barrel body including a first object-side surface;
a microstructure region located on the first object-side surface, wherein the microstructure region includes a plurality of microstructural portions; and
a protruding structure region surrounding the microstructure region, wherein the protruding structure region is closer to the object side than the microstructure region, so as to protect the microstructure region from damage; and
an optical lens assembly disposed in the lens barrel and comprising a plurality of optical lenses.

11. The lens module according to claim 10, wherein the protruding structure region is more protruding than the microstructure region, and has a protruding height of 0.005-0.50 mm.

12. The lens module according to claim 10, wherein the lens barrel is a two-piece lens barrel, the lens barrel further comprises a plurality of petal portions, the petal portions surround the first object-side surface of the barrel body, and each petal portion comprises a second object-side surface.

13. The lens module according to claim 12, wherein the protruding structure region completely surrounds the microstructure region, and the protruding structure region is located at an edge of the first object-side surface and an edge of the second object-side surface.

14. The lens module according to claim 12, wherein the protruding structure region partially surrounds the microstructure region, and the protruding structure region is located at an edge of the first object-side surface; the protruding structure region is located at an edge of the second object-side surface; or the protruding structure region is located on the entire surface of the second object-side surface.

15. The lens module according to claim 10, wherein the lens barrel is a one-piece lens barrel, the protruding structure region surrounds the microstructure region, and the protruding structure region is located at an edge of the second object-side surface.

16. The lens module according to claim 10, wherein the lens barrel is a one-piece lens barrel, the protruding structure region partially surrounds the microstructure region, and the protruding structure region is located at an edge of the first object-side surface.

17. The lens module according to claim 10, wherein the protruding structure region partially surrounds the microstructure region, the protruding structure region comprises at least two arc-shaped regions, and satisfies the following condition: 0.4≤a ratio of sum of lengths of the arc-shaped regions of the protruding structure region to a circumference of the first object-side surface≤0.9.

18. The lens module according to claim 10, wherein a roughness of the protruding structure region is from 0.005 mm to 0.030 mm, any area of 0.1 mm*0.1 mm in the microstructure region has n microstructural portions, and the following conditions are satisfied: 10≤n≤90.
